(19) United States
(12) Patent Application Publication
(10) Pub. No.: US 2022/0269790 A1
(43) Pub. Date: Aug. 25, 2022

(54) REAL-TIME AUTOMATED COMPLIANCE DEVIATION MONITORING AND REMEDIATION

(71) Applicant: ArcaWorx Inc., San Jose, CA (US)

(72) Inventors: Krishna Mohan RAJANA, Saratoga, CA (US); Bhasker Satyamurthy NALLAPOTHULA, San Jose, CA (US)

(21) Appl. No.: 17/183,439

(22) Filed: Feb. 24, 2021

(51) Int. Cl. G06F 21/57; G06F 9/455; G06F 9/54

(52) U.S. Cl. CPC G06F 21/577; G06F 9/45558; G06F 9/547; G06F 2009/45587; G06F 2009/45591

(57) ABSTRACT

Real-time automated remediation for compliance and deviation monitoring and remediation is provided. A compliance and security monitoring container pods orchestration environment may be configured to monitor an asset of a project or any project update to the project's configuration, asset, or assets hosted by a cloud computing environment, vulnerability of software hosted by the project and security of authorized end point devices accessing project resources. Upon triggering the compliance monitoring container pods orchestration environment to evaluate the asset for compliance, a compliance monitoring verification is performed to evaluate the asset to determine whether the asset is in a compliant state or a violation state. If the asset is in the violation state, then automated remediation is performed for the asset, wherein the automated remediation comprises at least one of performing a real-time automated remediation action for the asset or generating a real-time notification of a security compliance violation or deviation.

### BACKGROUND

Many businesses, service providers, and other entities utilize cloud computing environments, such as public clouds, to provide services to users, store data, host virtual machines, host websites, implement projects, host enterprise management suites (e.g., financial software, inventory management software, human resource software, etc.), etc. However, these cloud computing environments may not provide adequate security and operational verification of functionality implemented within the cloud computing environments and their authorized device access.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for real-time automated remediation for compliance and deviation monitoring and remediation are provided herein. A compliance monitoring container pods orchestration environment may be configured to monitor projects and assets of those projects that are hosted within a cloud computing environment. The projects may relate to any sort of functionality being implemented through the cloud computing environment, such as a finance project of financial software that utilizes various cloud assets for operation, a human resource project of human resource software the utilizes various cloud assets for operation, an inventory management project of inventory management software that utilizes various cloud assets for operation, etc. An asset may correspond to a cloud asset, such as a storage bucket, a virtual machine, processing resources, network resources, application instances, and/or a variety of other types hardware, software, or combinations thereof.

The compliance monitoring container pods orchestration environment may be configured with permissions and/or roles associated with the projects and/or assets. In some embodiments, a security scan and validation tool of the compliance monitoring container pods orchestration environment may be integrated into a workflow process for end-to-end processing of cloud service provisioning requests (e.g., provisioning of a new project or asset) while implementing security compliance for the projects and assets of the projects and their access policies.

Various trigger events, such as a user trigger, a scheduled compliance scan, an event corresponding to a change of an asset (e.g., an asset being created, deleted, or modified), expiration of a time period, etc., may trigger the compliance monitoring container pods orchestration environment to evaluate one or more assets of a project. Accordingly, the compliance monitoring container pods orchestration environment is executed to perform real-time compliance monitoring verification to evaluate the one or more assets to determine whether the one or more assets are in a compliant state or a violation state. For example, an asset may be evaluated to determine whether the asset is misconfigured, violates a security policy, has been modified by an entity, violates policy requirements for the asset access, etc. The real-time compliance monitoring verification may be performed before or after the project has been implemented for a production environment for providing services and functionality to users.

If the compliance monitoring verification determines that the asset is in the violation state, then automated remediation may be performed for the asset. In some embodiments, the automated remediation may perform a real-time automated remediation action for the asset (e.g., reconfigured the asset, modify the asset based upon a policy so that the asset is in compliance with the policy, decommission the asset, replace the asset with a new asset that is in compliance, etc.). In some embodiments, the automated remediation may comprise the generation of a real-time notification of a security compliance violation or deviation, or some other policy violation or deviation. If the compliance monitoring verification determines that the asset is in the compliant state, then the asset is marked as compliant.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of real-time automated remediation for compliance and deviation monitoring and remediation.

FIG. 2 is a flow diagram illustrating an exemplary method of real-time automated remediation for compliance and deviation monitoring and remediation.

FIG. 3 is a flow diagram illustrating an exemplary method of real-time automated remediation for compliance and deviation monitoring and remediation.

FIG. 4 is a flow diagram illustrating an exemplary method of real-time automated remediation for compliance and deviation monitoring and remediation.

FIG. 5 is a component block diagram illustrating an exemplary system for real-time automated remediation for compliance and deviation monitoring and remediation.

FIG. 6 is an illustration of an exemplary computer readable medium wherein processor-executable instructions configured to embody one or more of the provisions set forth herein may be comprised.

FIG. 7 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth to provide an understanding of the claimed subject matter. It may be evident, however, that the claimed subject matter may be practiced without these specific details. In other instances, structures and devices are illustrated in block diagram form in order to facilitate describing the claimed subject matter.

One or more systems and/or techniques for real-time automated remediation for compliance and deviation monitoring and remediation are provided herein. The real-time automated remediation is implemented by a compliance monitoring container pods orchestration environment. The compliance monitoring container pods orchestration environment is implemented to improve security, compliance management, and remediation of projects and assets of the projects hosted within a cloud computing environment. The compliance monitoring container pods orchestration environment is capable of identifying misconfigurations of projects and assets, user permission issues, policy violations, and/or other issues before deployment and/or after deployment of a project. The compliance monitoring container pods orchestration environment can implement customized rules and policies for cloud security, compliance, software security vulnerabilities, and end point access authorization. The compliance monitoring container pods orchestration environment implements a dashboard user interface that provides insight into what assets are part of a project, operational information of the assets, configuration information of the assets, policy violations or deviations of the assets, etc. The compliance monitoring container pods orchestration environment implements real-time automated remediation for assets that are in non-compliance, such as by executing real-time automated remediation actions and/or real-time notifications of compliance violations or deviations. The compliance monitoring container pods orchestration environment is built with an extensible architecture to support any number of projects and assets. In this way, the compliance monitoring container pods orchestration environment is capable of capturing various views of projects and assets, assessing the projects and assets using various policies and customized rules, generating reports, and enforcing the policies and customized rules.

In some embodiments regarding project operating environment standards compliance and remediation, the compliance monitoring container pods orchestration environment implements automated mediation in real-time by monitoring for compliance deviation and remediation in real-time using cloud messaging and command feed functionality to an embedded cloud SDK shell in a functionality loop. For example, SDK functionality is integrated into a service associated with the compliance monitoring container pods orchestration environment. The compliance monitoring container pods orchestration environment implements automated mediation in real-time, by monitoring for compliance integrated as a native tool and automatically keeps itself up-to-date with project information, asset information, and/or with other information such as in response to API changes and product changes requiring API adaptation. Thus, when a call for command to remediate is received, the SDK functionality is up-to-date and capable of performing the remediation. During production, the compliance monitoring container pods orchestration environment monitors parameters of cloud infrastructure associated with the projects and assets for real-time tracking, such as to track in-bound and out-bound traffic, which may be evaluated to determine that a project has not been compromised after being deployed. In some embodiments regarding project software vulnerability detection and patching ability, during development and before deployment of a project, a set of software libraries may be associated with the project. The security vulnerability monitoring module may assess the set of libraries for security vulnerabilities, in order to determine whether the project will encounter security issues during production, and thus the vulnerability monitoring module may provide a notification of potential vulnerabilities. In this way, the vulnerability monitoring module may be integrated into a pipeline used to construct software of a project that can apply security patches for the software libraries before being executed during production.

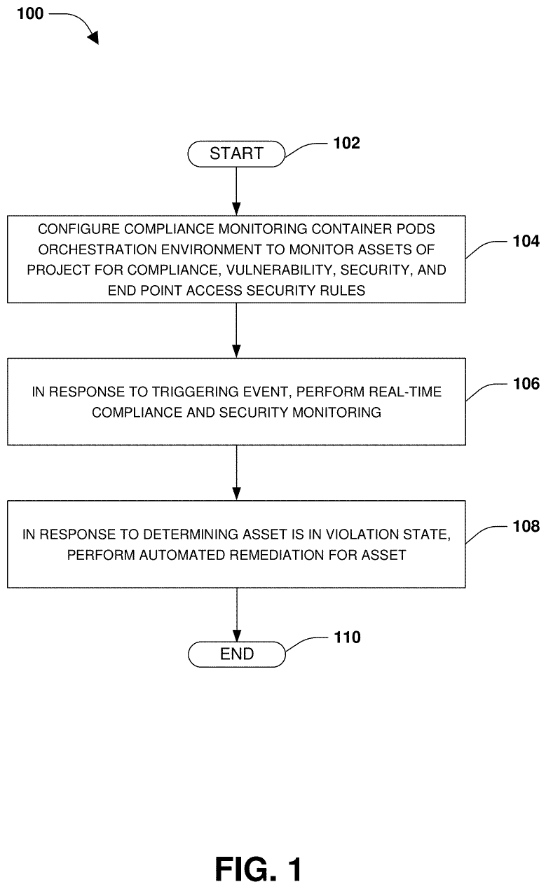

One embodiment of real-time automated remediation for compliance and deviation monitoring and remediation is illustrated by an exemplary method 100 of FIG. 1. The method 100 starts at 102. Users may generate projects that are hosted within a cloud computing environment utilizing assets, such as a storage bucket, a virtual machine, processing resources, network resources, application instances, cloud resources, and/or a variety of other type's hardware, software, or combinations thereof. The projects may be created during design time, and then subsequently deployed during production time for execution. The projects may be designed to implement various services and functionality, such as warehouse management functionality, business analytics functionality, website hosting, application hosting, enterprise software hosting, financial management functionality, etc.

During operation 104 of the method 100, a compliance monitoring container pods orchestration environment is configured to monitor one or more projects and/or one or more assets of the projects hosted by the cloud computing environment. In an example, the compliance monitoring container pods orchestration environment is configured to monitor a warehousing project configured to provide users with warehousing functionality utilizing assets of the cloud computing environment. The compliance monitoring container pods orchestration environment may be configured to a permission, credentials (e.g., credentials to access the project and/or one or more assets of the project through the cloud computing environment), authorized device access, and/or a role associated with a project and/or the one or more assets of the project to monitor. In some embodiments, a policy may be specified for enforcement by the compliance monitoring container pods orchestration environment. The policy may specify certain levels of security, expected/allowed access and usage of the project, expected/allowed actions and interactions with the project, an expected/allowed configuration of an asset, etc. The policy may comprise customized rules that may be applied by the compliance monitoring container pods orchestration environment for evaluating information, configuration, security, access, utilization, and/or operation of the project and/or assets of the project for monitoring for compliance with the policy. In an example of configuring the compliance monitoring container pods orchestration environment for monitoring, a security scan and validation tool of the compliance monitoring container pods orchestration environment may be integrated into a workflow for end-to-end processing of cloud service provisioning requests of projects and assets of the projects with security compliance. For example, when a cloud service provisioning request to provision an asset (e.g., a cloud resource) for the project is received, the security scan and validation tool may evaluate the cloud service provisioning request to determine whether the provisioning of the asset would violate the policy and/or customized rules, which may relate to security compliance, configuration compliance, etc.

The compliance monitoring container pods orchestration environment may be configured to trigger real-time compliance monitoring verification in response to various triggering events. A triggering event may corresponds to a user trigger (e.g., a user command to perform monitoring), a scheduled compliance scan, an event correspond to a change of an asset of the project or a change to the project (e.g., the creation, deletion, or modification of an asset), expiration of a time period, etc.

During operation 106 of the method 100, a real-time compliance monitoring verification is performed to evaluate the asset based upon the triggering event triggering the compliance monitoring container pods orchestration environment to evaluate the asset for compliance. The compliance monitoring container pods orchestration environment may perform the real-time compliance monitoring verification to determine whether the asset is in a compliant state or a violation state with respect to one or more polices and/or rules defined for the asset and/or the project associated with the asset. In some embodiments, the compliance monitoring container pods orchestration environment may perform the real-time compliance monitoring verification to execute a rule to whether the asset is misconfigured (e.g., a value for a parameter may be set for the asset that is outside an allowed value range for the parameter). In some embodiments, the compliance monitoring container pods orchestration environment may perform the real-time compliance monitoring verification to determine whether a security policy for the asset has been violated.

In some embodiments, the compliance monitoring container pods orchestration environment may perform the real-time compliance monitoring verification to determine whether unauthorized or unexpected access to the asset has been performed and/or whether unauthorized or unexpected actions have been performed with respect to the asset. In some embodiments, the compliance monitoring container pods orchestration environment may perform the real-time compliance monitoring verification to read metadata, associated with the asset such as parameters within a configuration of the asset, from the cloud computing environment. The compliance monitoring container pods orchestration environment may compare the metadata to a policy requirement for the asset to determine whether the asset is in compliance or violation with respect to the policy requirement. In some embodiments, the compliance monitoring container pods orchestration environment may perform the real-time compliance monitoring verification to determine whether a change has occurred to the asset and the entity that changed the asset, so that an alert of the change and the entity may be generated.

During operation 108 of the method 100, the compliance monitoring container pods orchestration environment performs automated remediation for the asset in response to the compliance monitoring verification determining that the asset is in the violation state. In some embodiments, the compliance monitoring container pods orchestration environment may perform the automated remediation to execute a real-time automated remediation action for the asset, such as to modify a configuration of the asset to put the asset into the compliant state, block access to the asset, stop operation of the asset, deconstruct the asset, deconstruct the asset and replace the asset with a new asset in the compliant state etc. In some embodiments, a cloud software development kit (SDK) is utilized to implement the automated remediation using an up-to-date API for executing the automated remediation within the cloud computing environment for the asset. In some embodiments, the compliance monitoring container pods orchestration environment may perform the automated remediation to generate a real-time notification of a compliance violation or deviation, such as a security compliance violation or deviation.

In some embodiments, in response to the compliance monitoring container pods orchestration environment determining that the asset is in the violation state, a new compliance monitoring verification may be performed upon other assets of the project in order to identify any ripple effect causing the other assets of the project to be in the violation state. In some embodiments, in response to the compliance monitoring container pods orchestration environment determining that the asset is in the violation state as a current violation, the compliance monitoring container pods orchestration environment performs remediation for the project to rescan the assets of the project in order to identify any ripple effect causing the assets of the project to be in the violation state. While the compliance monitoring container pods orchestration environment is addressing/remediating the current violation of the asset, the compliance monitoring container pods orchestration environment may perform a new compliance monitoring verification to identify any misconfigurations associated with one or more projects hosted by the cloud computing environment. In this way, the compliance monitoring container pods orchestration environment may implement multitasking for addressing misconfigurations and remediating non-compliance.

In some embodiments, the compliance monitoring container pods orchestration environment may perform a new compliance monitoring verification to evaluate assets of the project in response to a parameter associated with a configuration of the project being modified. In this way, the compliance monitoring container pods orchestration environment may perform new compliance monitoring verifications in response to on-the-fly project reconfigurations. In some embodiments, the compliance monitoring container pods orchestration environment may perform a new compliance monitoring verification to evaluate assets of the project in response to a policy change (e.g., a security policy may be modified with a new rule, removal of a rule, or modification of an existing rule).

In some embodiments, the compliance monitoring container pods orchestration environment may implement workload image vulnerability detection. A scan may be triggered based upon a schedule. The scan may be to execute the workload image vulnerability detection to determine if a vulnerability exploit exists with respect to the project and/or assets of the project. If the vulnerability exploit exists, then a notification of the vulnerability exploit is provided through a message channel. The creation of a new workload image and/or implementation of a security path may be triggered.

In some embodiments, a dashboard user interface may be populated with information by the compliance monitoring container pods orchestration environment for display to a user. The compliance monitoring container pods orchestration environment may populate the dashboard user interface with results of the compliance monitoring verification. The compliance monitoring container pods orchestration environment may populate the dashboard user interface with visualizations of assets of the project (e.g., an icon or image of an asset may be displayed such that a user may interface with the icon or image in order to obtain additional information about the asset, such as a current configuration, any violations, etc.). The compliance monitoring container pods orchestration environment may populate the dashboard user interface with violation information, policy information, rule information, policy and rule customization and creation functionality, remediation options, enforcement options, analytics of a project and assets of the project, a report or graph of the analytics, etc. The dashboard user interface may allow a user to add, delete, and/or modify projects. The dashboard user interface may allow the user to view, remove, or provision assets for the projects. The method 100 ends at 110.

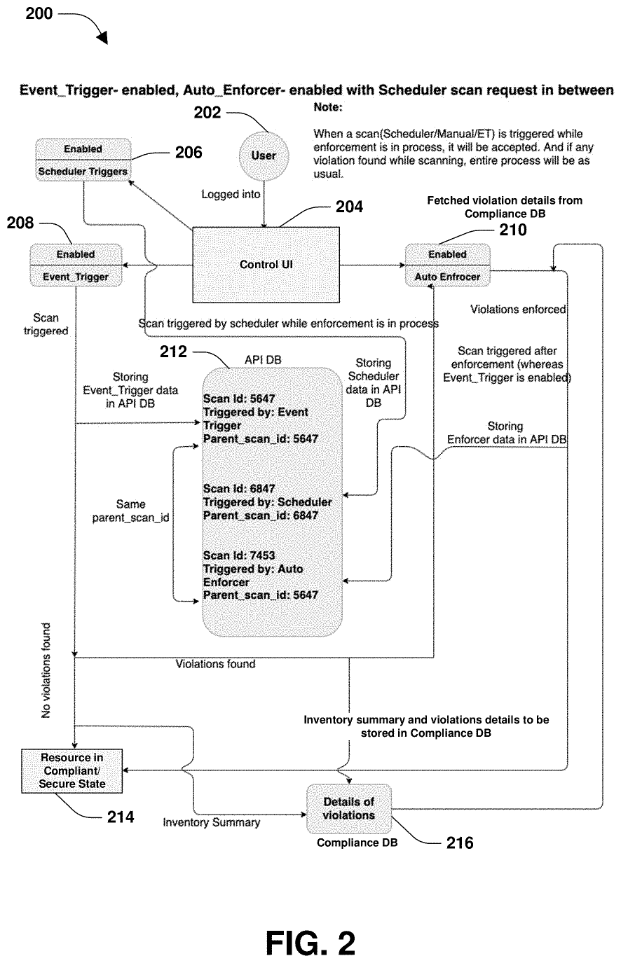

FIG. 2 illustrates a remediation workflow 200 where an event trigger is enabled, an auto-enforcer is enabled, and a scheduler scan request is triggered during enforcement. In some embodiments, a compliance monitoring container pods orchestration environment may implement the remediation workflow 200. A user 202 may log into a user interface 204 (e.g., a control user interface that implements various dashboard user interfaces). The user 202 may utilize the user interface 204 to enable scheduler triggers 206 to schedule scans that perform real-time compliance monitoring verifications of projects and assets. The user 202 may utilize the user interface 204 to enable event triggers 208 to trigger scans that perform real-time compliance monitoring verifications of projects and assets. The user 202 may utilize the user interface 204 to enable auto-enforcer 210 to automatically perform enforcement of policies and rules for projects and assets.

The user interface 204 may be hosted by a compliance monitoring container pods orchestration environment that stores information within an API database 212, such as event trigger data, scheduler data, enforcer data, information regarding projects and assets to enforce, etc. The compliance monitoring container pods orchestration environment may store identified violations within a database 216, such as information relating to what assets have violated what policies and rules, what automatic remediation was taken or suggested, etc. The compliance monitoring container pods orchestration environment may also store information 214 about assets and projects that are in a compliant state (resources in a secure state). Remediation workflow 200 illustrates the workflow performed when a scheduler scan request is triggered (e.g., a manual trigger, an event trigger occurring, a scheduled scan being triggered) while enforcement by the compliance monitoring container pods orchestration environment is in process. If any violations are identified, such as where the compliance monitoring container pods orchestration environment identifies an asset in a violation state, then the compliance monitoring container pods orchestration environment may perform automated remediation, such as by performing a real-time automated remediation action or generating a real-time notification of a violation or deviation from a policy or rule.

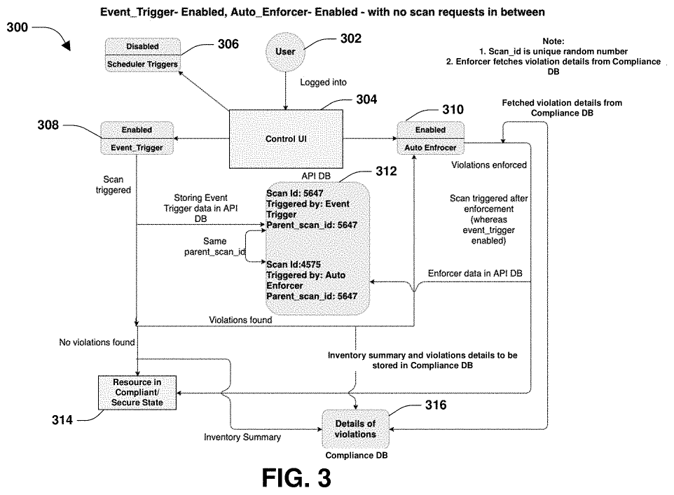

FIG. 3 illustrates a remediation workflow 300 where an event trigger is enabled, an auto-enforcer is enabled, and there is no pending scan request to implement. In some embodiments, a compliance monitoring container pods orchestration environment may implement the remediation workflow 300. A user 302 may log into a user interface 304 (e.g., a control user interface that implements various dashboard user interfaces). The user 302 may utilize the user interface 304 to enable scheduler triggers 306 to schedule scans that perform real-time compliance monitoring verifications of projects and assets. The user 302 may utilize the user interface 304 to enable event triggers 308 to trigger scans that perform real-time compliance monitoring verifications of projects and assets. The user 302 may utilize the user interface 304 to enable auto-enforcer 310 to automatically perform enforcement of policies and rules for projects and assets.

The user interface 304 may be hosted by a compliance monitoring container pods orchestration environment that stores information within an API database 312, such as event trigger data, scheduler data, enforcer data, information regarding projects and assets to enforce, scan data (e.g., a scan identifier that is a unique random number, what event triggered the scan, a parent scan identifier, etc.), etc. The compliance monitoring container pods orchestration environment may store identified violations within a database 316, such as information relating to what assets have violated what policies and rules, what automatic remediation was taken or suggested, etc. The compliance monitoring container pods orchestration environment may also store information 314 about assets and projects that are in a compliant state (resources in a secure state). Remediation workflow 300 illustrates the workflow performed during enforcement. For example, violation details may be fetched from the database 316. Violations identified from the violation details may be enforced. For example, if any violations are identified, such as where the compliance monitoring container pods orchestration environment identifies an asset in a violation state, then the compliance monitoring container pods orchestration environment may perform automated remediation, such as by performing a real-time automated remediation action or generating a real-time notification of a violation or deviation from a policy or rule.

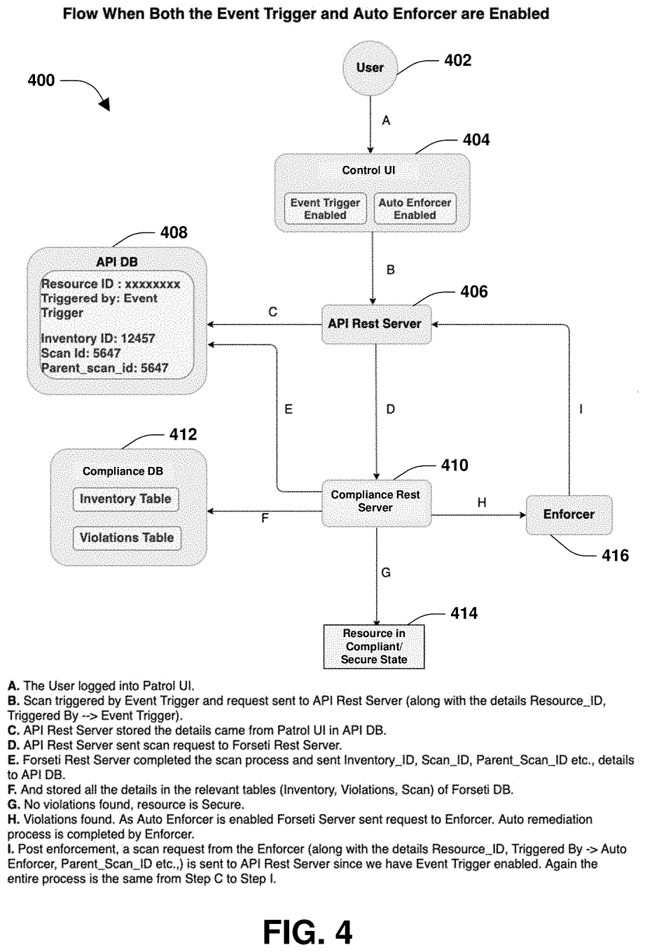

FIG. 4 illustrates a workflow 400 where an event trigger is enabled and an auto-enforcer is enabled. In some embodiments, a compliance monitoring container pods orchestration environment may implement the workflow 400. At operation (A) of workflow 400, a user 402 logs into a user interface 404 (e.g., a control user interface). The user interface 404 may indicate that the event trigger and the auto-enforcer are enabled. During operation (B) of workflow 400, a scan is triggered by an event trigger. Accordingly, a scan request is transmitted to an API rest server 406, along with details of a resource identifier to scan (e.g., an identifier of an asset within a cloud computing environment) and a triggered by field indicating what triggered the scan (e.g., a manual trigger, a timer timing out, a modification to a project, a scheduled scan, an occurrence of an event, etc.). During operation (C) of workflow 400, the API rest server 406 may store the details associated with the scan request from the user interface 404 within an API database 408. During operation (D) of workflow 400, the API rest server 406 may send a scan request to a rest server 410. During operation (E) of workflow 400, the rest server 410 may perform a scan that implements real-time compliance monitoring evaluation of the resource (e.g., a project and/or assets of the project) to determine whether the resource is in a compliant state or a violation state. The rest server 410 sends details of the scan to an API database 408, such as a resource identifier of what was scanned, a scan identifier of the scan, a parent scan identifier, etc.

During operation (F) of workflow 400, the details from the rest server 410 are stored within relevant tables of a database 412, such as within an inventory table, a violations table, a scan table, etc. During operation (G) of workflow 400, a determination is made that the resource is secure in a compliant state 414 based upon no violations being identified. During operation (H) of workflow 400, if any violations are identified, then a scan request from an enforcer 416 is triggered. The scan request, along with details regarding a resource identifier of a resource in violation, a triggered by field set to indicate that the scan request is automatically triggered by the enforce 416 based upon the identification of the violation(s), a parent scan identifier, and/or other information, is sent to the API rest server 406 since the event trigger is enabled. In this way, operations (C) through (I) may be performed to address the violation.

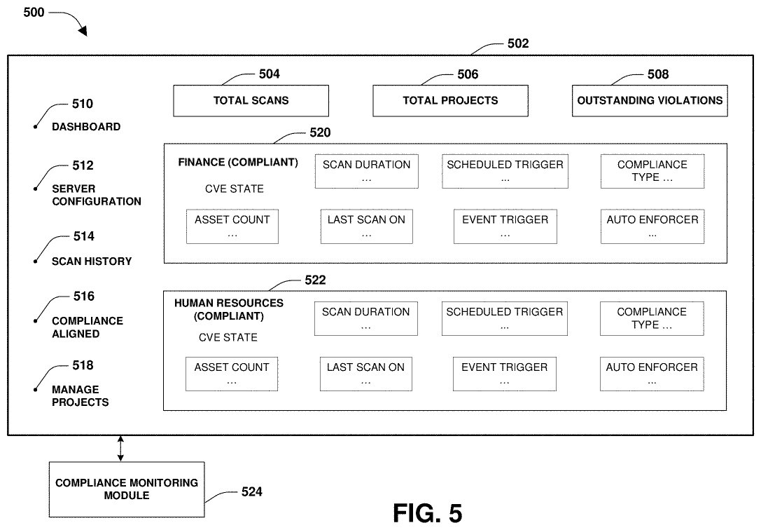

FIG. 5 illustrates a system 500 for real-time automated remediation for compliance and deviation monitoring and remediation. A compliance monitoring container pods orchestration environment 524 may be configured to populate and display a user interface 502 (e.g., a control user interface). The user interface 502 may be populated within options, such as a dashboard option 510 to view details about scan information 504, project information 506, outstanding violations 508, details about projects such as a finance project interface 520, a human resources project interface 522, etc. The finance project interface 520 and the human resources project interface 522 may provide information related to an asset count of the project (e.g., a project has 47 assets), a scan duration of a scan that performed real-time compliance monitoring evaluations (e.g., 1 hour and 18 minutes), a date of a last scan (January 5th, 2020 at 2:00 pm PDT), scheduled trigger information (e.g., scheduled triggers are enabled or disabled), event trigger information (e.g., event triggers are enabled or disabled), auto-enforcer information (e.g., an auto-enforcer is enabled or disabled), compliance type information (e.g., best practices, HIPAA, government specified requirements, health sector specific requirements, financial institution specified requirements, etc.), violation information (e.g., secure with no violations, 3 violations, etc.), the ability to specify or upload a policy file of a policy to implement, the ability to define scan triggers, the ability to load configuration and rule files, etc. In some embodiments, a CVE State may be associated with a project, such as where the CVE State is color coded to reflect a risk state, such as critical, high, medium, or low, which may be maintained within a global Common Vulnerabilities and Exposures database.

The dashboard option 510 may provide other details, such as project information, resources information (e.g., asset information, such as compute engine assets, storage assets, cloud function assets), database utilization information, compute engine utilization information, billing information, monitoring information through which, policies such as alerting policies may be established, cloud computing environment status, asset health, search functionality to search for projects, etc. The compliance monitoring container pods orchestration environment 524 may populate the user interface 502 with other options, such as a server configuration option 512, a scan history option 514, a compliance aligned option 516 (e.g., the ability to assign policies and rules to projects and view compliance), a manage projects option 518 (e.g., the ability to modify a project, add a project, delete a project), etc.

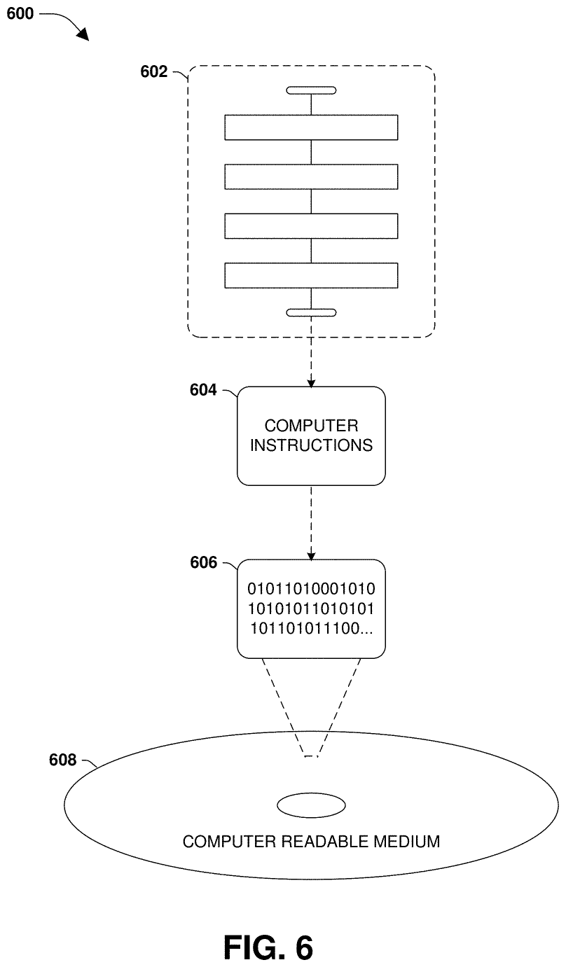

Still another embodiment involves a computer-readable medium comprising processor-executable instructions configured to implement one or more of the techniques presented herein. An example embodiment of a computer-readable medium or a computer-readable device is illustrated in FIG. 6, wherein the implementation 600 comprises a computer-readable medium 608, such as a CD-R, DVD-R, flash drive, a platter of a hard disk drive, etc., on which is encoded computer-readable data 606. This computer-readable data 606, such as binary data comprising at least one of a zero or a one, in turn comprises a set of computer instructions 604 configured to operate according to one or more of the principles set forth herein. In some embodiments, the processor-executable computer instructions 604 are configured to perform a method 602, such as at least some of the exemplary method 100 of FIG. 1, for example. In some embodiments, the processor-executable instructions 604 are configured to implement a system configured to implement the techniques described herein such as system 500 of FIG. 5, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

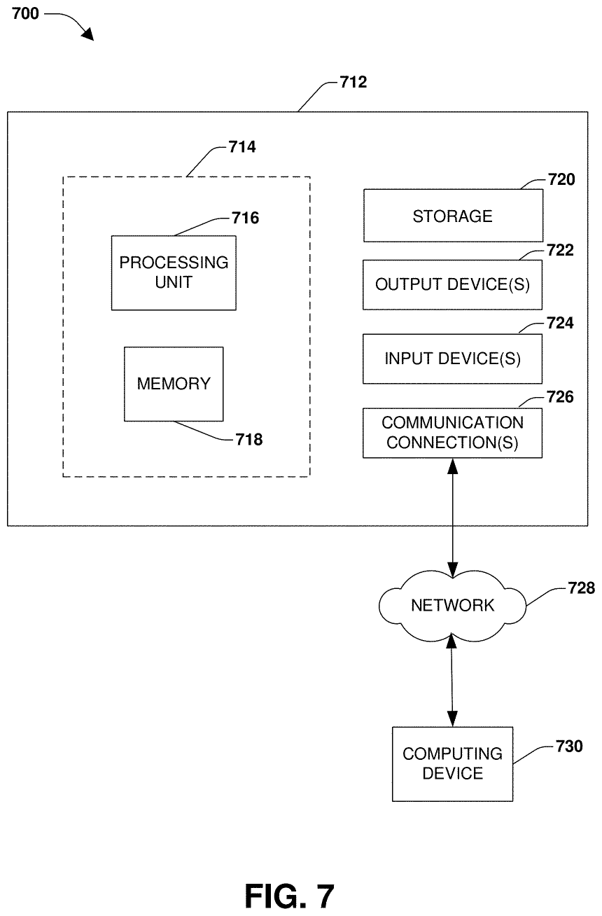

FIG. 7 and the following discussion provide a brief, general description of a suitable computing environment to implement embodiments of one or more of the provisions set forth herein. The operating environment of FIG. 7 is only one example of a suitable operating environment and is not intended to suggest any limitation as to the scope of use or functionality of the operating environment. Example authorized computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 7 illustrates an example of a system 700 comprising a computing device 712 configured to implement one or more embodiments provided herein. In one configuration, computing device 712 includes at least one processing unit 716 and memory 718. Depending on the exact configuration and type of computing device, memory 718 may be volatile (such as RAM, for example), non-volatile (such as ROM, flash memory, etc., for example) or some combination of the two. This configuration is illustrated in FIG. 7 by dashed line 714.

In other embodiments, device 712 may include additional features and/or functionality. For example, device 712 may also include additional storage (e.g., removable and/or non-removable) including, but not limited to, magnetic storage, optical storage, and the like. Such additional storage is illustrated in FIG. 7 by storage 720. In one embodiment, computer readable instructions to implement one or more embodiments provided herein may be in storage 720. Storage 720 may also store other computer readable instructions to implement an operating system, an application program, and the like. Computer readable instructions may be loaded in memory 718 for execution by processing unit 716, for example.

The term “computer readable media” as used herein includes computer storage media. Computer storage media includes volatile and nonvolatile, removable and non-removable media implemented in any method or technology for storage of information such as computer readable instructions or other data. Memory 718 and storage 720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 712. Computer storage media does not, however, include propagated signals. Rather, computer storage media excludes propagated signals. Any such computer storage media may be part of device 712.

Device 712 may also include communication connection(s) 726 that allows device 712 to communicate with other devices. Communication connection(s) 726 may include, but is not limited to, a modem, a Network Interface Card (NIC), an integrated network interface, a radio frequency transmitter/receiver, an infrared port, a USB connection, or other interfaces for connecting computing device 712 to other computing devices. Communication connection(s) 726 may include a wired connection or a wireless connection. Communication connection(s) 726 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 712 may include input device(s) 724 such as keyboard, mouse, pen, voice input device, touch input device, infrared cameras, video input devices, and/or any other input device. Output device(s) 722 such as one or more displays, speakers, printers, and/or any other output device may also be included in device 712. Input device(s) 724 and output device(s) 722 may be connected to device 712 via a wired connection, wireless connection, or any combination thereof. In one embodiment, an input device or an output device from another computing device may be used as input device(s) 724 or output device(s) 722 for computing device 712.

Components of computing device 712 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 712 may be interconnected by a network. For example, memory 718 may be comprised of multiple physical memory units located in different physical locations interconnected by a network.

Those skilled in the art will realize that storage devices utilized to store computer readable instructions may be distributed across a network. For example, a computing device 730 accessible via a network 728 may store computer readable instructions to implement one or more embodiments provided herein. Computing device 712 may access computing device 730 and download a part or all of the computer readable instructions for execution. Alternatively, computing device 712 may download pieces of the computer readable instructions, as needed, or some instructions may be executed at computing device 712 and some at computing device 730.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application can generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

1. A method comprising:
configuring a compliance monitoring container pods orchestration environment to monitor an asset of a project hosted by a cloud computing environment;
in response to a triggering event triggering the compliance monitoring container pods orchestration environment to evaluating the asset for compliance, performing a real-time compliance monitoring verification to evaluate the asset to determine whether the asset is in a compliant state or a violation state; and
in response to the compliance monitoring verification determining that the asset is in the violation state, performing automated remediation for the asset, wherein the automated remediation comprises at least one of performing a real-time automated remediation action for the asset or generating a real-time notification of a security compliance violation or deviation.

2. The method of claim 1, comprising:
utilizing a cloud software development kit to implement the automated remediation utilizing an up-to-date API and CLI.

3. The method of claim 1, wherein the configuring comprises:
specifying at least one of a permission or a role associated with at least one of the assets or the project.

4. The method of claim 1, comprising:
configuring the compliance monitoring container pods orchestration environment to monitor a plurality of assets, including the asset, of the project.

5. The method of claim 4, comprising:
in response to the compliance monitoring container pods orchestration environment determining that the asset is in the violation state, performing a new compliance monitoring verification upon the plurality of assets of the project.

6. The method of claim 4, comprising:
in response to the compliance monitoring container pods orchestration environment determining that the asset is in the violation state as a current violation, performing remediation for the project to rescan the plurality of assets of the project.

7. The method of claim 6, wherein the performing remediation for the project comprises:
while addressing the current violation, performing a new compliance monitoring verification to identify misconfigurations associated with one or more projects hosted by the cloud computing environment.

8. The method of claim 1, wherein the performing the compliance monitoring verification comprises:
reading metadata associated with the asset; and
comparing the metadata to a policy requirement for the asset to determine whether the asset is in compliance or violation with respect to the policy requirement.

9. The method of claim 1, wherein the performing the compliance monitoring verification comprises:
determining whether a change has occurred to the asset and identifying an entity that changed the asset; and
generating an alert of the change and the entity if the change causes the entity to be in violation.

10. The method of claim 1, comprising:
in response to a parameter associated with a configuration of the project being modified, performing a new compliance monitoring verification to evaluate assets of the project.

11. The method of claim 1, comprising:
in response to identifying a policy change, performing a new compliance monitoring verification to evaluate assets of the project.

12. The method of claim 1, comprising:
displaying results of the compliance monitoring verification on a user interface displayed on a display.

13. A non-transitory machine readable medium comprising instructions for performing a method, which when executed by a machine, causes the machine to:
configure a compliance monitoring container pods orchestration environment to monitor a plurality of assets of a project hosted by a cloud computing environment;
in response to a triggering event triggering the compliance monitoring container pods orchestration environment to evaluate the plurality of assets for compliance, perform a compliance monitoring verification to evaluate the plurality of assets to determine whether the plurality of assets are in a compliant state or a violation state; and
in response to determining that an asset of the plurality of assets is in the violation state:
performing a remediation for the asset; and
initiating a new compliance monitoring verification to rescan the plurality of assets of the project.

14. The non-transitory machine readable medium of claim 13, wherein the instruction cause the machine to:
display visualizations of the plurality of assets of the project through a user interface.

15. The non-transitory machine readable medium of claim 13, wherein the triggering event corresponds to at least one of a user trigger, a scheduled compliance scan, an expiration of a time period, or an event corresponding to at least one of a change to one or more assets or an update to a project configuration.

16. The non-transitory machine readable medium of claim 13, wherein the instruction cause the machine to:
display a user interface through which projects can be added, deleted, and modified, wherein the user interface is populated with at least one of:
violation information;
remediation options;
enforcement options;
analytics of the project and the plurality of assets; or
a report or a graph associated with the analytics.

17. The non-transitory machine readable medium of claim 13, wherein the instruction cause the machine to:
implement application workload image vulnerability detection upon an application workload image corresponding to business logic;
trigger a scan based upon a schedule to execute the workload image vulnerability detection to determine if a vulnerability exploit exists;
provide a notification of the vulnerability exploit through a message channel; and
trigger creation of a new workload image or implementation of a security patch ready for redeployment.

18. The non-transitory machine readable medium of claim 13, wherein the instruction cause the machine to:
implement endpoint security violation detection upon accessing an project asset(s) or application workload image(s) corresponding to business logic;
trigger a scan based upon a schedule to execute the endpoint security violation detection to determine if an unauthorized or unsafe endpoint device access exists;
provide a notification of the unsafe or unauthorized access through a message channel; and
trigger a response to remediate unsafe or unauthorized access and restoring to secured and compliant state of project.

19. The non-transitory machine readable medium of claim 13, wherein the instruction cause the machine to:
integrate a security scan and validation tool of the compliance monitoring container pods orchestration environment with a workflow process for end-to-end processing of cloud service provisioning requests with security compliance.

20. A computing device comprising:
a memory comprising machine executable code for performing a method; and
a processor coupled to the memory, the processor configured to execute the machine executable code to cause the processor to:
configure a compliance monitoring container pods orchestration environment to monitor an asset of a project hosted by a cloud computing environment;
in response to a triggering event triggering the compliance monitoring container pods orchestration environment to evaluate the asset for compliance, perform a compliance monitoring verification to evaluate the asset to determine whether the asset is in a compliant state or a violation state; and
in response to the compliance monitoring verification determining that the asset is in the complaint state, marking the asset as being in compliance.
